(19) United States
(12) Patent Application Publication
(10) Pub. No.: US 2010/0251013 A1
(43) Pub. Date: Sep. 30, 2010

(54) METHOD FOR PROCESSING BAD BLOCK IN REDUNDANT ARRAY OF INDEPENDENT DISKS

(75) Inventors: Hai-Ting Yao, Tianjin (CN); Qing-Xiu Wu, Tianjin (CN); Tom Chen, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei (TW)

(21) Appl. No.: 12/411,889

(22) Filed: Mar. 26, 2009

(51) Int. Cl. G06F 11/00; G06F 11/20; G06F 12/00

(52) U.S. Cl. 714/7; 711/114; 711/E12.001; 711/E12.103; 714/E11.085

(57) ABSTRACT

A method for processing a bad block in a redundant array of independent disks (RAID) is presented, which is characterized by a software RAID constructed by a scale computer interface disk, and adapted to backup data in a bad block in the software RAID. The method includes invoking an access error program to intercept an access instruction for a data block in the software RAID when the data block is a bad block; searching a disk number and a logical block address of the data block in the software RAID according to the access instruction; selecting the scale computer interface disk; and mapping data stored in the data block, the disk number, and the logical block address to a reserved local memory of the scale computer interface disk. Through the above steps, the data in the bad block can be mapped to a normal block, thus maintaining the data integrity.

### BACKGROUND OF THE INVENTION

1. Field of Invention

The present invention relates to a method for processing a bad block, and more particularly to a method for processing a bad block in a redundant array of independent disks (RAID).

2. Related Art

In order to improve the data access efficiency of a hard disk, an access mode of writing data to a plurality of hard disks in parallel is proposed. Such an access mode is called a redundant array of independent disks (RAID). In short, the RAID is a logical sector formed by combining a plurality of hard disks. Therefore, in view of an operating system, the RAID is merely considered as an independent hard disk. The RAID further includes various access modes, and is, for example, classified into RAID-0, RAID-1, RAID-1E, RAID-5, RAID-6, RAID-10, and RAID-50.

As the data writing mode of the RAID is distributing and writing data to different hard disks, when an error occurs to a hard disk, data stored in the hard disk cannot be accessed, resulting in damage to the data. In order to avoid this case, the RAID calculates a check code of the data during the data writing process. As such, when an error occurs to a hard disk, the RAID can revoke original data according to the check code, so as to prevent the entire RAID from being out of operation due to the damage to the hard disk. However, if a large number of hard disks are damaged, the system cannot repair data according to the mechanism based on check codes.

In the prior art, when an error occurs to a sector (or a track) in a hard disk, the hard disk is directly deleted. As a result, it is not only difficult to repair the damaged data, but the storage capacity of the RAID is also affected.

### SUMMARY OF THE INVENTION

Accordingly, the present invention is a method for processing a bad block in a redundant array of independent disks (RAID), which is characterized by a RAID constructed by a scale computer interface disk, and particularly, adapted to backup data in a bad block in the software RAID.

To achieve the above objective, a method for processing a bad block in a RAID disclosed in the present invention comprises the following steps: receiving an access request for accessing data in a data block in the RAID; executing an access error program to extract the access request for the data block, if the accessed data block is the bad block; searching a disk number of the scale computer interface disk corresponding to the data block in the RAID and a logical block address of the data block according to the access request; obtaining a reserved local memory in the scale computer interface disk; and mapping the data stored in the data block, the disk number, and the logical block address to the reserved local memory.

The present invention provides a RAID with a bad block processing function and a method thereof, which utilize the reserved local memories in the scale computer interface disk to store data in a portion of bad blocks in the RAID. As such, the direct deletion of the damaged disk can be avoided, and the data integrity can further be ensured.

### BRIEF DESCRIPTION OF THE DRAWINGS

The present invention will become more fully understood from the detailed description given herein below for illustration only, and thus are not limitative of the present invention, and wherein:

FIG. 1A is a schematic structural view of the present invention;

FIG. 1B is a schematic view of data blocks;

FIG. 2 is a schematic flow chart of a bad block processing program;

FIG. 3 is a schematic flow chart of an access error program; and

FIG. 4 is a schematic flow chart of a step for searching a disk number of the scale computer interface disk and a logical block address of the data block.

### DETAILED DESCRIPTION OF THE INVENTION

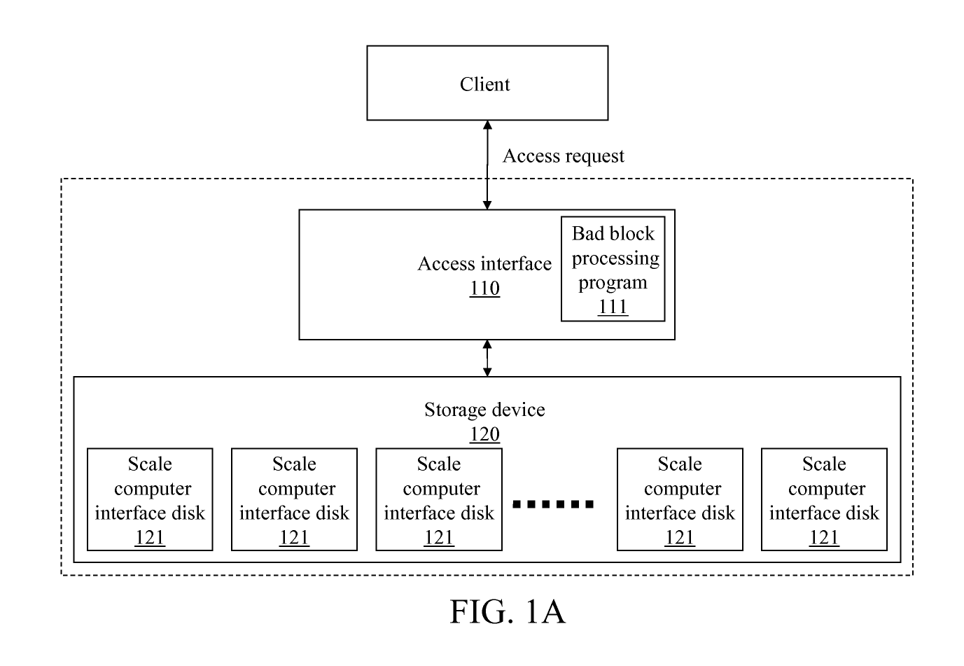

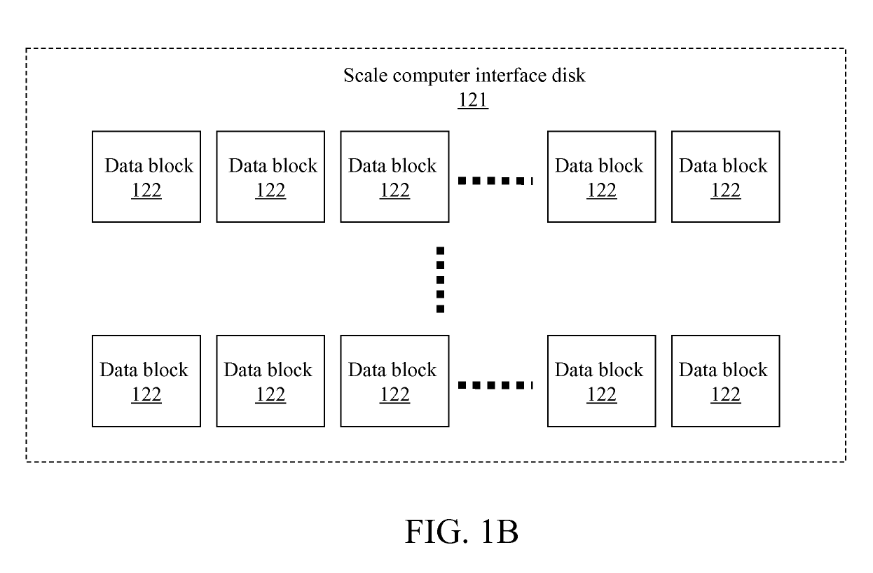

FIG. 1A is a schematic structural view of the present invention. Referring to FIG. 1A, a redundant array of independent disks (RAID) with a bad block processing function of the present invention comprises an access interface 110 and a storage device 120. The storage device 120 is a RAID formed by a plurality of scale computer interface disks 121. The present invention is applicable to RAIDs with a check code function. For example, the present invention may be any one of RAID-1, RAID-1E, RAID-5, RAID-6, RAID-10, and RAID-50.

FIG. 1B is a schematic view of data blocks. Each scale computer interface disk 121 is designated with a corresponding disk number. The storage device 120 further comprises a plurality of data blocks 122, and each data block 122 has a corresponding logical block address. The access interface 110 is connected to the storage device 120 and a client. The access interface 110 is used for receiving an access request from the client and invoking data stored in the storage device 120 according to the access request. The access interface 110 further comprises a bad block processing program 111. A portion of the data blocks 122 may be reserved in each scale computer interface disk 121 to serve as reserved local memories. The number of the data blocks 122 occupied by the reserved local memories varies with different manufacturers. When an accessed data block 122 is a bad block, the access interface 110 executes the corresponding bad block processing program.

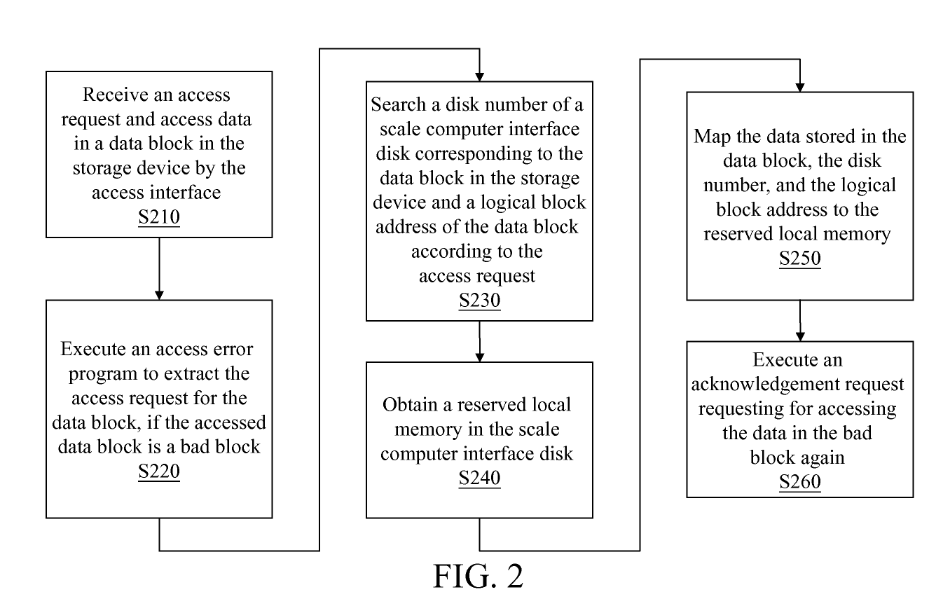

FIG. 2 is a schematic flow chart of a bad block processing program. Referring to FIG. 2, the bad block processing program 111 comprises the following steps.

In Step S210, the access interface receives an access request and accesses data in a data block in the storage device (i.e., the RAID).

In Step S220, if the accessed data block is a bad block, an access error program is executed to extract the access request for the data block.

In Step S230, a disk number of a scale computer interface disk corresponding to the data block in the storage device and a logical block address of the data block are searched according to the access request.

In Step S240, a reserved local memory in the scale computer interface disk is obtained.

In Step S250, the data stored in the data block, the disk number, and the logical block address are mapped to the reserved local memory.

In Step S260, an acknowledgement request requesting for accessing the data in the bad block again is executed.

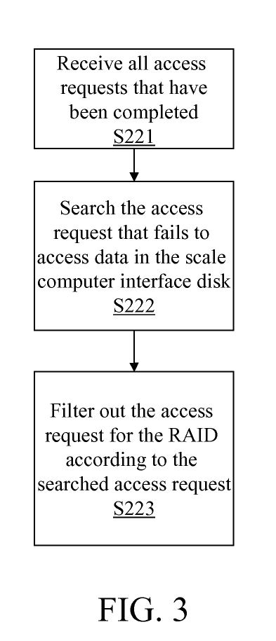

When an error occurs to the access to the data block, the access error program is executed to extract the access request for the data block. The step of executing the access error program further comprises the following steps, as shown in FIG. 3.

In Step S221, all access requests that have been completed are received.

In Step S222, the access request that fails to access data in the scale computer interface disk is searched.

In Step S223, the access request for the RAID is filtered out according to the searched access request.

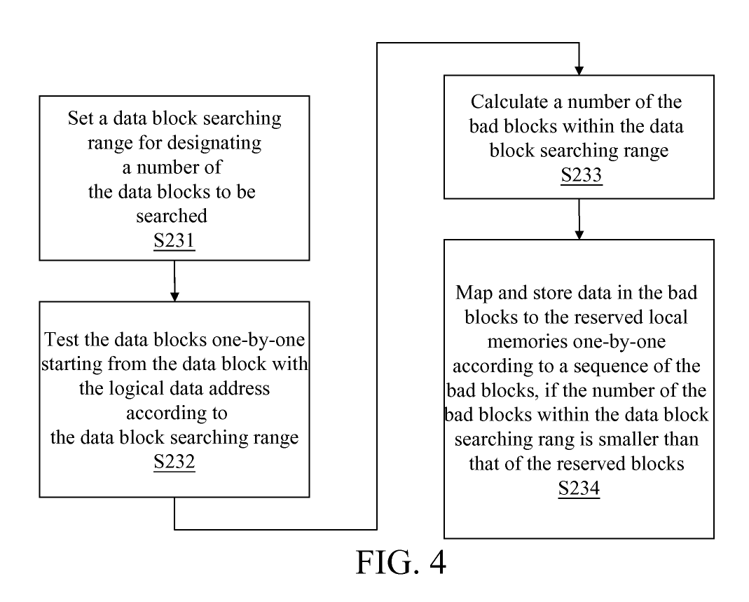

As described above, the scale computer interface disk 121 may have several reserved local memories. In general, the reserved local memories are used for providing storage space for testing or storing relevant messages to the manufacturer. For general users, the reserved local memories are invisible. When a sector in the scale computer interface disk 121 is damaged, a bad block remapping function can be used to render the logical block address to point to a new sector in the reserved space, thus repairing the physical sector in the scale computer interface disk 121. However, for a storage system, the reserved local memories can be accessed through access instructions. The Step S230 of searching the disk number of the scale computer interface disk and the logical block address of the data block 122 further comprises the following steps, as shown in FIG. 4.

In Step S231, a data block searching range is set for designating a number of the data blocks to be searched.

In Step S232, the data blocks are tested one-by-one starting from the data block with the logical data address according to the data block searching range.

In Step S233, a number of the bad blocks within the data block searching range is calculated.

In Step S234, if the number of the bad blocks within the data block searching rang is smaller than that of the reserved blocks, data in the bad blocks is mapped to and stored in the reserved local memories one-by-one according to a sequence of the bad blocks.

The present invention provides a RAID with a bad block processing function and a method thereof, which utilize the reserved local memories in the scale computer interface disk 121 to store data in a portion of bad blocks in the RAID. As such, the direct deletion of the damaged disk can be avoided, and the data integrity can further be ensured.

What is claimed is:

1. A method for processing a bad block in a redundant array of independent disks (RAID), characterized by a RAID constructed by a scale computer interface disk, and particularly, adapted to backup data in a bad block in the RAID, the method comprising:
receiving an access request for accessing data in a data block of the RAID;
executing an access error program to extract the access request for the data block, if the accessed data block is the bad block;
searching a disk number of the scale computer interface disk corresponding to the data block in the RAID and a logical block address of the data block according to the access request;
obtaining a reserved local memory in the scale computer interface disk; and
mapping the data stored in the data block, the disk number, and the logical block address to the reserved local memory.

2. The method for processing a bad block in a RAID according to claim 1, wherein the step of executing the access error program further comprises:
receiving all access requests that have been completed;
searching the access request that fails to access data in the scale computer interface disk; and
filtering out the access request for the RAID according to the searched access request.

3. The method for processing a bad block in a RAID according to claim 1, wherein the step of searching the disk number and the logical block address further comprises:
setting a data block searching range for designating a number of the data blocks to be searched;
testing the data blocks one-by-one starting from the data block with the logical data address according to the data block searching range;
calculating a number of the bad blocks within the data block searching range; and
mapping and storing data in the bad blocks to the reserved local memories one-by-one according to a sequence of the bad blocks, if the number of the bad blocks within the data block searching rang is smaller than that of the reserved blocks.

4. The method for processing a bad block in a RAID according to claim 1, wherein after the mapping is completed, the method further comprises:
executing an acknowledgement request requesting for accessing the data in the bad block again.
